(19) United States
(12) Patent Application Publication
(10) Pub. No.: US 2026/0046524 A1
(43) Pub. Date: Feb. 12, 2026

(54) IMAGE PROCESSING APPARATUS, IMAGE PROCESSING METHOD, AND NON-TRANSITORY COMPUTER READABLE MEDIUM

(71) Applicant: CANON KABUSHIKI KAISHA, Tokyo (JP)

(72) Inventor: NARUMI MATSUOKA, Kanagawa (JP)

(21) Appl. No.: 19/288,574

(22) Filed: Aug. 1, 2025

(30) Foreign Application Priority Data
Aug. 9, 2024 (JP) 2024-134318

(51) Int. Cl. H04N 23/73; H04N 23/80

(52) U.S. Cl. CPC H04N 23/73; H04N 23/80

(57) ABSTRACT

An image processing apparatus according to the present disclosure includes a processor and a memory, wherein in a second display mode, in a case where an exposure time reaches an upper limit, brightness adjustment processing is performed, the brightness adjustment processing being processing of increasing display brightness of a display image data in a display to display brightness substantially equal to display brightness in a first display mode.

### BACKGROUND

### Field of the Technology

The present disclosure relates to an image processing apparatus, an image processing method, and a program, and particularly relates to a technique for improving visibility of a display image corresponding to a low brightness scene.

### Description of the Related Art

As a display mode of a camera, there has been proposed a display mode for controlling an exposure time of an imaging element (a charge accumulation time, in the imaging element, according to light radiated to the imaging element) so that live view display (LV display) is performed with a desired display brightness. However, when the exposure time is long, LV display with a non-smooth motion (LV display with a jerky motion) is performed.

There has also been proposed a display mode that prioritizes smoothness of LV display and limits an exposure time to a predetermined time or less. However, since the exposure time is limited to a predetermined time or less, LV display darker than a desired display brightness is performed in a case where a night scene is photographed or in a case where a dark lens with a large open F-number is used.

Japanese Patent Laid-Open No. 2007-110220 discloses a technique of increasing display brightness by image processing when surroundings are dark at the time of increasing the display brightness in response to an instruction from a user.

However, there is also an upper limit to an increase amount of display brightness by the image processing, and thus a desired display brightness may not be achieved even with the technique disclosed in Japanese Patent Laid-Open No. 2007-110220.

### SUMMARY

The present disclosure provides a technique enabling a desired display brightness to be achieved also in a display mode that prioritizes smoothness, or the like.

The present disclosure its first aspect provides an image processing apparatus including a processor, and a memory storing a program which, when executed by the processor, causes the image processing apparatus to acquire captured image data captured by an image sensor, set one of a plurality of display modes including a first display mode, and a second display mode in which an upper limit of an exposure time of the image sensor is shorter than in the first display mode, control the exposure time on a basis of brightness of the captured image data, generate display image data to be displayed on a display on a basis of the captured image data, and display the display image data on the display, wherein in the second display mode, in a case where the exposure time reaches the upper limit, brightness adjustment processing is performed, the brightness adjustment processing being processing of increasing display brightness of the display image data in the display to display brightness substantially equal to display brightness in the first display mode.

The present disclosure its second aspect provides an image processing method including acquiring captured image data captured by an image sensor, setting one of a plurality of display modes including a first display mode, and a second display mode in which an upper limit of an exposure time of the image sensor is shorter than in the first display mode, controlling the exposure time on a basis of brightness of the captured image data, generating display image data to be displayed on a display on a basis of the captured image data, and displaying the display image data on the display, wherein in the second display mode, in a case where the exposure time reaches the upper limit, brightness adjustment processing is performed, the brightness adjustment processing being processing of increasing display brightness of the display image data in the display to display brightness substantially equal to display brightness in the first display mode.

The present disclosure its third aspect provides a non-transitory computer readable medium that stores a program, wherein the program causes a computer to execute an image processing method including acquiring captured image data captured by an image sensor, setting one of a plurality of display modes including a first display mode, and a second display mode in which an upper limit of an exposure time of the image sensor is shorter than in the first display mode, controlling the exposure time on a basis of brightness of the captured image data, generating display image data to be displayed on a display on a basis of the captured image data, and displaying the display image data on the display, wherein in the second display mode, in a case where the exposure time reaches the upper limit, brightness adjustment processing is performed, the brightness adjustment processing being processing of increasing display brightness of the display image data in the display to display brightness substantially equal to display brightness in the first display mode.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a digital camera.

FIG. 2 is a block diagram of an image processing unit.

FIG. 3 is a flowchart illustrating operation of the digital camera.

FIG. 4 is a table showing a specific example of an increase rate of display brightness.

### DESCRIPTION OF THE EMBODIMENTS

Hereinafter, an embodiment of the present disclosure will be described. Note that, although an example in which the present disclosure is applied to an imaging apparatus will be described, an apparatus to which the present disclosure can be applied is not limited to the imaging apparatus. The present disclosure is applicable to various electronic apparatuses (image processing apparatus) capable of performing image processing on an image captured (captured image). For example, the present disclosure is applicable to a digital camera, a digital video camera, a personal computer, a tablet terminal, a smartphone, a mobile phone, a game machine, a video see-through type head mounted display, and the like.

### Digital Camera

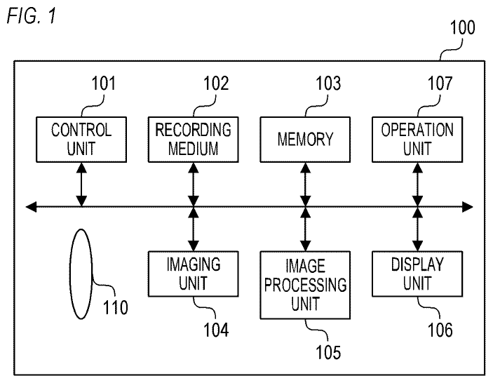

FIG. 1 is a block diagram illustrating a functional configuration of a digital camera 100 according to the present embodiment. Each unit of the digital camera 100 illustrated in FIG. 1 may be hardware such as a circuit or a processor, or may be realized by a program.

A control unit 101 includes at least one processor or circuit and controls each unit of the digital camera 100. For example, the control unit 101 controls each unit of the digital camera 100 by reading a program from a recording medium 102, developing the program in a memory 103, and executing the program.

The recording medium 102 is a non-volatile recording device enabling electrical erasing and recording of information (data), and is, for example, a Flash-ROM. The recording medium 102 stores programs, constants, and the like for controlling each unit of the digital camera 100. The recording medium 102 may also serve as a recording medium (e.g., a semiconductor memory card) that stores an image (RAW data, image data after development processing, and the like) obtained by imaging.

The memory 103 is a volatile recording device, and is, for example, a RAM, a DRAM, or the like. The memory 103 is used as a development area of a program for controlling each unit of the digital camera 100. The memory 103 is also used as a VRAM when an image is displayed on a display unit 106.

A lens unit 110 forms an optical image by light from an object onto an imaging surface of the lens unit 110. The lens unit 110 may be detachable from the digital camera 100. Although the lens unit 110 usually includes a plurality of lenses (imaging lens group), only one lens is illustrated in FIG. 1 for simplicity. The lens unit 110 includes a control circuit (not illustrated), and the control circuit controls a state of the lens unit 110 on the basis of a drive signal input from the control unit 101.

An imaging unit 104 is, for example, an imaging element such as a CCD or a CMOS sensor, and acquires an analog image signal by converting an optical image formed on the imaging surface by the lens unit 110 into an electrical signal. The acquired analog image signal is converted into a digital image signal (RAW data) by an A/D converter (not illustrated). In the present embodiment, the imaging unit 104 is assumed to be a single-plate color imaging element including a general primary color filter. In the primary color filter, three types of color filters having transmission main wavelength bands (wavelength bands of light mainly transmitted) in the vicinity of 650 nm, the vicinity of 550 nm, and the vicinity of 450 nm are disposed in a mosaic form (in a Bayer arrangement). The imaging unit 104 uses the primary color filter to image color planes of three colors corresponding to a red (R) band, a green (G) band, and a blue (B) band, respectively. At this time, each photoelectric conversion element of the imaging unit 104 can only obtain a light intensity corresponding to a single color plane. Note that the imaging unit 104 is not limited to a single-plate color imaging element. The imaging unit 104 may include a peripheral circuit such as an amplifier circuit that processes a signal obtained from each photoelectric conversion element.

An image processing unit 105 performs various types of image processing such as pixel interpolation, resizing, and color conversion on the RAW data output from the imaging unit 104 or the image data read from the recording medium 102. Furthermore, the image processing unit 105 acquires information necessary for exposure control and distance measurement control by performing arithmetic processing using the RAW data obtained by imaging. In the digital camera 100, through-the-lens (TTL) type autofocus (AF) processing, auto exposure (AE) processing, and flash pre-emission (EF) processing are performed on the basis of the information obtained from the image processing unit 105. Furthermore, TTL type automatic white balance (AWB) processing and the like are also performed.

A display unit 106 is a display device such as a liquid crystal display, for example, and displays a GUI such as a setting value, a message, and a menu screen of the digital camera 100, a captured image, and the like. The display unit 106 may be, for example, an electronic viewfinder (EVF) or a rear liquid crystal display provided in the digital camera 100, or may be an external display connected to the digital camera 100. In any of the electronic viewfinder, the rear liquid crystal display, and the external display, live view display (LV display) showing an object in substantially real time is possible.

The display unit 106 includes a display control circuit (not illustrated), and the display control circuit can change a maximum display brightness (upper limit display brightness) of the display unit 106 on the basis of the drive signal input from the control unit 101. The maximum display brightness of the display unit 106 may be dynamically controlled according to a Bv value (brightness value) obtained by photometry of an imaging scene, or may be controlled according to an imaging mode. The photometry of the imaging scene may be performed on the basis of an image signal obtained by imaging, or may be performed on the basis of an output of a photometric sensor provided separately from the imaging unit 104, or the like.

A operation unit 107 is a user interface that receives various user operations. When detecting a user operation, the operation unit 107 outputs a control signal corresponding to the user operation to the control unit 101. The operation unit 107 includes a release switch for instructing start of photographing preparation operation and start of photographing (main photographing), a mode selection switch for selecting the imaging mode or a display mode, a direction key, an enter key, and the like.

### Image Processing Unit

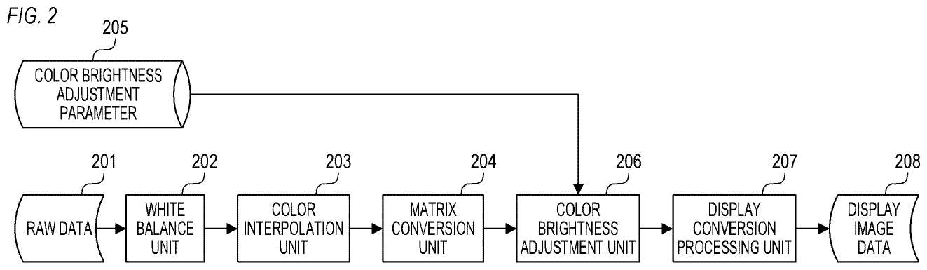

FIG. 2 is a block diagram illustrating a functional configuration of the image processing unit 105. The imaging unit 104 includes the primary color filter in which the three types of color filters are disposed in a mosaic form. Therefore, RAW data 201 (captured image data that is captured by the imaging unit 104) is a color mosaic image. The image processing unit 105 reads the RAW data 201 from the memory 103, performs the development processing, and generates display image data 208.

A white balance unit 202 performs, on the RAW data 201, white balance processing that is color conversion processing for increasing a reproduction degree of white color of the object. The white balance unit 202 plots each RGB data included in the RAW data 201 in a predetermined color space such as an xy color space. The RGB data is data obtained from three or more photoelectric conversion elements corresponding to the color planes of the three colors of RGB. The white balance unit 202 integrates an R value, a G value, and a B value of the RGB data plotted near a locus of black body radiation having a high possibility of a light source color. Then, the white balance unit 202 calculates white balance coefficients (G integral value/R integral value and G integral value/B integral value) of the R value and the B value from the calculated integral value, and corrects each RGB data using the white balance coefficients. As a result, color fogging due to the light source can be reduced to enhance the reproduction degree of the white color of the object.

A color interpolation unit 203 performs noise reduction processing and color interpolation processing on the image data after the white balance processing. In general, since random noise increases as ISO sensitivity of the imaging unit 104 increases, stronger noise reduction processing is performed as the ISO sensitivity increases. The color conversion processing is processing of obtaining a value of a color component not included in pixel data (data corresponding to a single color plane obtained from one photoelectric conversion element). The image data including the R value, the G value, and the B value for all the pixels is generated by the color conversion processing.

A matrix conversion unit 204 performs matrix conversion processing on the image data generated by the color interpolation unit 203. As a result, general color image data is obtained.

A color brightness adjustment unit 206 performs color brightness adjustment processing of adjusting at least one of color and brightness on the color image data generated by the matrix conversion unit 204. The color brightness adjustment processing is, for example, contrast correction, exposure correction, saturation correction, sharpness correction, and the like performed using a color brightness adjustment parameter 205.

A display conversion processing unit 207 generates the display image data 208 by converting at least one of a color gamut and a gamma characteristic of image data after the color brightness adjustment processing so as to match a color gamut and a gamma characteristic of the display unit 106.

The display image data 208 (the image corresponding to the display image data 208) generated in this manner is displayed on the display unit 106, resulting in realizing the LV display.

### Display Mode

In the present embodiment, the control unit 101 sets one of a plurality of display modes including a visibility priority mode and a smoothness priority mode as a display mode of the LV display. The visibility priority mode is a display mode in which priority is given to the visibility of the LV display, and is a display mode in which an upper limit of an exposure time of the imaging unit 104 is relatively long. The smoothness priority mode is a display mode in which priority is given to the smoothness of the LV display, and is a display mode in which the upper limit of the exposure time of the imaging unit 104 is shorter than that in the visibility priority mode. The plurality of display modes that can be set may include display modes other than the visibility priority mode and the smoothness priority mode.

### Visibility Priority Mode

In the visibility priority mode, the control unit 101 controls at least one of the ISO sensitivity and the exposure time of the imaging unit 104 on the basis of brightness of the captured image data (e.g., RAW data) captured by the imaging unit 104. Here, the captured image data is not limited to the RAW data. For example, the captured image data may be image data after the white balance processing, the noise reduction processing, the color interpolation processing, the matrix conversion processing, the contrast correction, the exposure correction, the saturation correction, the sharpness correction, color gamut conversion, or gamma conversion (gamma processing).

In a case of a high brightness scene such as a daytime scene, or in a case where an F-number of the lens unit 110 is small (bright), even when the ISO sensitivity is low or the exposure time is short, the imaging unit 104 is irradiated with a sufficient amount of light. As a result, display brightness of the LV display (display brightness of the display image data) matching exposure setting designated by the user can be realized. On the other hand, in a case of a low brightness scene such as a night scene or in a case where the F-number of the lens unit 110 is large (dark), when the ISO sensitivity is low or the exposure time is short, the imaging unit 104 is not irradiated with a sufficient amount of light. Therefore, without an increase in the ISO sensitivity or an extension of the exposure time, the display brightness of the LV display suitable for the exposure setting cannot be realized. Increasing the ISO sensitivity increases noise to deteriorate LV display quality. When an accumulation time is extended, smoothness of a motion in the LV display is reduced, and LV display in which the motion is jerky is performed. For example, when the accumulation time is extended to 1/10 seconds, a frame rate of the LV display becomes 10 fps. Note that the exposure setting may be automatically determined by the digital camera 100 without being designated by the user.

### Conventional Smoothness Priority Mode

Also in the smoothness priority mode, the control unit 101 controls at least one of the ISO sensitivity and the exposure time of the imaging unit 104 on the basis of the brightness of the captured image data (e.g., RAW data) captured by the imaging unit 104. As described above, in the smoothness priority mode, the upper limit of the exposure time is lower than that in the visibility priority mode.

As described above, in the visibility priority mode, the LV display in which the motion is jerky may be performed by extending the accumulation time. In the LV display in which the motion is jerky, followability of an object is poor, and there is a high risk that the user misses a photo opportunity in a case of photographing a moving object. In the smoothness priority mode, by using a time shorter than that in the visibility priority mode as the upper limit of the exposure time, smooth LV display can be performed also in the low brightness scene. For example, in the smoothness priority mode, when the upper limit of the exposure time is 1/60 seconds, smooth LV display can be performed at a frame rate of 60 fps or more. Note that the upper limit of the exposure time in the smoothness priority mode is not limited to 1/60 seconds, and may be 1/120 seconds, 1/30 seconds, or the like.

### Smoothness Priority Mode of the Present Embodiment

In a conventional smoothness priority mode, since a long exposure time cannot be set, an exposure time is insufficient to make exposure insufficient in a low brightness scene, and live view display with poor visibility is performed.

Therefore, in the present embodiment, in the smoothness priority mode, when the exposure time reaches the upper limit, the brightness adjustment processing of increasing the display brightness of the LV display is performed by at least one of the image processing unit 105 and the display unit 106 (the display control circuit). By the brightness adjustment processing, the display brightness of the LV display is increased to display brightness substantially equal to the display brightness in the visibility priority mode.

Thus, a desired display brightness can be achieved also in the smoothness priority mode, and both smoothness and visibility can be obtained in the smoothness priority mode.

Here, it is assumed that the ISO sensitivity has reached the upper limit. In this case, a difference between the display brightness of the LV display in the visibility priority mode and display brightness of the LV display in the conventional smoothness priority mode is caused by a difference in exposure time. As a method for reducing such a difference in display brightness, there are three possible methods (first to third methods) as follows.

First method is a method of performing brightness increasing processing of increasing brightness, such as applying a digital gain to the RAW data 201. Second method is a method of performing the brightness increasing processing on image data in the development processing (which may be interpreted as after the development processing), for example, image data after the color interpolation processing or the matrix conversion processing. Third Method is a method of increasing display brightness by control of the display unit 106.

In the first method, for example, a digital gain is applied to the RAW data 201 using a digital amplifier or the like. Since the brightness is increased before the development processing, image quality degradation such as dark part noise and color fogging cannot be sufficiently reduced in the development processing, so that low quality LV display in which the object is difficult to be visually recognized is performed in the low brightness scene.

In the second method, for example, the brightness increasing processing is performed by at least one of the color brightness adjustment unit 206 and the display conversion processing unit 207. Since the brightness increasing processing is performed after the noise reduction processing by the color interpolation unit 203, LV display in which noise is less noticeable than in the first method can be performed.

The brightness increasing processing by the color brightness adjustment unit 206 is, for example, processing of switching a gamma curve for contrast correction according to an increase amount of the display brightness of the LV display for an increase to display brightness substantially equal to the display brightness in the visibility priority mode. The brightness increasing processing by the color brightness adjustment unit 206 is not limited thereto, and may be, for example, processing of applying a digital gain to image data.

In the brightness increasing processing by the display conversion processing unit 207, for example, degamma processing using an inverse characteristic (inverse gamma curve) of the gamma curve used by the color brightness adjustment unit 206 is performed on the image data (image data after the gamma processing) output from the color brightness adjustment unit 206. Brightness of the image data after the degamma processing (image data having a linear characteristic in which the brightness linearly changes with respect to a change of a gradation value) is increased according to the increase amount of the display brightness of the LV display for an increase to display brightness substantially equal to the display brightness in the visibility priority mode. Then, the same gamma processing as the gamma processing performed by the color brightness adjustment unit 206 (the gamma processing using the same gamma curve as the gamma curve used by the color brightness adjustment unit 206) is performed on the image data whose brightness has been increased. The brightness increasing processing by the display conversion processing unit 207 is not limited thereto, and may be, for example, processing of applying a digital gain to image data.

In the third method, for example, display setting of the display unit 106 is not changed, and a correspondence relationship between a pixel value (gradation value) of the display image data and the display brightness is temporarily changed by the display control circuit of the display unit 106. As a result, display brightness corresponding to the pixel value (gradation value) of the display image data is temporarily increased.

Although bit precision of each processing is not particularly limited, in the present embodiment, it is assumed that the bit precision decreases from an upstream to a downstream of the processing. The bit precision may be constant in a part from an upstream end to a downstream end of the processing. For example, it is assumed that the RAW data 201 is generated with 14 bit precision, processing is performed with 10 bit precision in the color brightness adjustment unit 206 and the display conversion processing unit 207, and processing is performed with 8 bit precision in the display unit 106. In order to suppress image quality degradation such as tone jump, it is preferable to increase the display brightness by processing with high bit precision.

From the above reasons, the second method is considered to be most suitable from the viewpoint of suppressing image quality degradation such as noise and tone jump. However, when the display brightness is excessively increased by the second method, dark part noise may be noticeable or visibility of a peaking processing result may be deteriorated. Although the noise reduction processing may be enhanced according to the increase amount of the display brightness by the second method, when the noise reduction processing is too enhanced, resolution of the image is lost. There is also an upper limit to an amount of noise that can be reduced. Furthermore, in a case of enhancing the noise reduction processing according to the increase amount of the display brightness, since it is necessary to prepare a plurality of noise reduction parameters corresponding to a plurality of increase amounts of the display brightness, the number of parameters held in the memory 103 increases, and the memory 103 with a large capacity is required. Therefore, an upper limit is also set to the increase amount of the display brightness by the second method.

In the present embodiment, in a case where the display brightness of the LV display does not increase to display brightness substantially equal to the display brightness in the visibility priority mode even when the display brightness is increased by the upper limit of the increase amount by the second method, the display brightness is further increased by the third method.

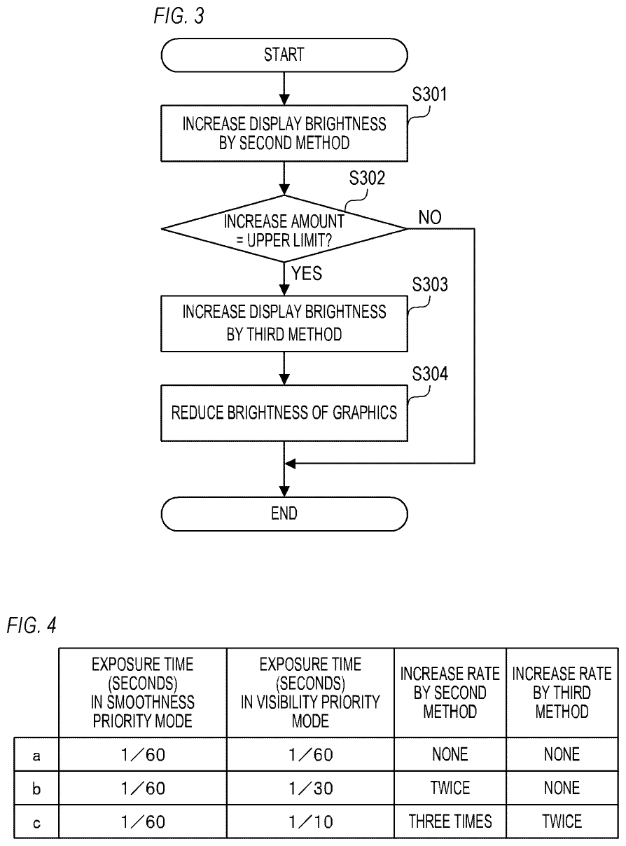

FIG. 3 is a flowchart illustrating operation according to the present embodiment (operation of the digital camera 100 in the smoothness priority mode).

In step S301, the control unit 101 controls the image processing unit 105 to increase the display brightness of the LV display by the second method.

In step S302, the control unit 101 determines whether the increase amount of the display brightness by the second method has reached the upper limit or not. Information on the upper limit of the increase amount is stored in advance in the recording medium 102, for example. The determination in step S302 may be interpreted as a determination as to whether or not the display brightness of the LV display has been increased to display brightness substantially equal to the display brightness in the visibility priority mode. When the increase amount of the display brightness by the second method has reached the upper limit (in a case where the display brightness of the LV display has yet to been increased to the display brightness substantially equal to the display brightness in the visibility priority mode), the processing proceeds to step S303. In a case where the increase amount of the display brightness by the second method is yet to reach the upper limit (in a case where the display brightness of the LV display has been increased to the display brightness substantially equal to the display brightness in the visibility priority mode), the operation of FIG. 3 is ended.

In step S303, the control unit 101 controls the display unit 106 (the display control unit) to increase the display brightness of the LV display by the third method.

In the present embodiment, the image processing unit 105 performs synthesis processing of synthesizing (combining) graphics data with captured image data such that a synthesized image in which graphics is superimposed on an LV image (image based on captured image data) representing an object in substantially real time is displayed on the display unit 106. The graphics is, for example, an on-screen display (OSD) image. Therefore, when the display brightness is increased by the third method, not only the display brightness of the LV image but also the display brightness of the graphics is increased. As a result, even when the display brightness of the LV image can be made substantially equal to the display brightness in the visibility priority mode, the display brightness of the graphics becomes higher than the display brightness in the visibility priority mode. In this case, since the graphics is bright, the LV image may be perceived as dark to reduce the visibility of the LV image.

Therefore, in the present embodiment, in a case where the processing of S303 is performed, processing of step S304 is performed. In step S304, the control unit 101 controls the image processing unit 105 according to the increase amount of the display brightness by the third method to reduce the brightness of the graphics data. Consequently, the display brightness of the graphics can be kept constant before and after the increase in the display brightness of the LV display (LV image) by the third method.

By the foregoing operation, it is possible to suitably improve the visibility in the smoothness priority mode from the viewpoint of suppressing image quality degradation such as noise and tone jump and from a viewpoint of suppressing an increase in the memory capacity required for the noise reduction processing.

FIG. 4 is a table showing a specific example of an increase amount (increase rate) of the display brightness by the second method and an increase amount (increase rate) of the display brightness by the third method. Although an upper limit of the increase rate of the display brightness by the second method is not particularly limited, it is assumed to be three times here.

In a pattern a of FIG. 4, the scene is sufficiently bright, and the LV display can be performed with display brightness substantially equal to the display brightness in the visibility priority mode without increasing the display brightness by the second method, the third method, or the like in the smoothness priority mode. Therefore, in the pattern a, the display brightness is not increased by the second method, the third method, or the like.

In a pattern b of FIG. 4, the scene is slightly dark, and in the visibility priority mode, the exposure time is extended to 1/20 seconds in order to realize display brightness suitable for the exposure setting by the user. In the smoothness priority mode, the exposure time can be extended only up to 1/60 seconds. Therefore, unless the display brightness is increased by the second method, the third method, or the like, the display brightness of the LV display becomes half (½ times) the display brightness in the visibility priority mode. Therefore, in the pattern b, the display brightness is doubled by the second method.

In a pattern c of FIG. 4, the scene is very dark, and in the visibility priority mode, the exposure time is extended to 1/10 seconds in order to realize display brightness matching the exposure setting by the user. In the smoothness priority mode, since the exposure time can be extended only up to 1/60 seconds, unless the display brightness is increased by the second method, the third method, or the like, the display brightness of the LV display becomes ⅙ times the display brightness in the visibility priority mode. Therefore, also in the pattern c, the display brightness is increased by the second method. Although it is necessary to increase the display brightness by six times, since the upper limit of the increase rate of the display brightness by the second method is three times, the display brightness is increased by three times by the second method. Then, the display brightness is doubled by the third method.

As described above, according to the present embodiment, a desired display brightness can be achieved also in the smoothness priority mode, and both smoothness and visibility can be obtained in the smoothness priority mode.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, desired display brightness can be achieved also in a display mode that prioritizes smoothness.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-134318, filed Aug. 9, 2024, which is hereby incorporated by reference herein in its entirety.

What is claimed is:

1. An image processing apparatus comprising:
a processor; and
a memory storing a program which, when executed by the processor, causes the image processing apparatus to
acquire captured image data captured by an image sensor,
set one of a plurality of display modes including a first display mode, and a second display mode in which an upper limit of an exposure time of the image sensor is shorter than in the first display mode,
control the exposure time on a basis of brightness of the captured image data,
generate display image data to be displayed on a display on a basis of the captured image data, and
display the display image data on the display, wherein
in the second display mode, in a case where the exposure time reaches the upper limit, brightness adjustment processing is performed, the brightness adjustment processing being processing of increasing display brightness of the display image data in the display to display brightness substantially equal to display brightness in the first display mode.

2. The image processing apparatus according to claim 1, wherein
the brightness adjustment processing includes at least one of image processing on the captured image data and control of the display.

3. The image processing apparatus according to claim 2, wherein
in the second display mode, in a case where the exposure time reaches the upper limit, the image processing is performed,
an increase amount of display brightness by the image processing has an upper limit, and
the control of the display is performed in a case where the display brightness of the display image data is not increased to display brightness substantially equal to the display brightness in the first display mode only by the image processing.

4. The image processing apparatus according to claim 2, wherein
synthesis processing of synthesizing graphic data with the captured image data is performed such that a synthesized image in which a graphic is superimposed on an image based on the captured image data is displayed on the display, and
in a case where the control of the display is performed, brightness of the graphic data is reduced so as to prevent an increase in display brightness of the graphic due to the control.

5. The image processing apparatus according to claim 2, wherein
the image processing is implemented by switching a gamma curve for use in generation of the display image data according to an increase amount of the display brightness of the display image data for an increase to display brightness substantially equal to the display brightness in the first display mode.

6. The image processing apparatus according to claim 2, wherein
in the image processing, degamma processing is performed on image data after gamma processing, brightness of the image data after the degamma processing is increased according to an increase amount of the display brightness of the display image data for an increase to display brightness substantially equal to the display brightness in the first display mode, and the gamma processing is performed on the image data after the brightness is increased.

7. An image processing method comprising:
acquiring captured image data captured by an image sensor;
setting one of a plurality of display modes including a first display mode, and a second display mode in which an upper limit of an exposure time of the image sensor is shorter than in the first display mode;
controlling the exposure time on a basis of brightness of the captured image data;
generating display image data to be displayed on a display on a basis of the captured image data; and
displaying the display image data on the display, wherein
in the second display mode, in a case where the exposure time reaches the upper limit, brightness adjustment processing is performed, the brightness adjustment processing being processing of increasing display brightness of the display image data in the display to display brightness substantially equal to display brightness in the first display mode.

8. A non-transitory computer readable medium that stores a program, wherein the program causes a computer to execute an image processing method comprising:
acquiring captured image data captured by an image sensor;
setting one of a plurality of display modes including a first display mode, and a second display mode in which an upper limit of an exposure time of the image sensor is shorter than in the first display mode;
controlling the exposure time on a basis of brightness of the captured image data;
generating display image data to be displayed on a display on a basis of the captured image data; and
displaying the display image data on the display, wherein
in the second display mode, in a case where the exposure time reaches the upper limit, brightness adjustment processing is performed, the brightness adjustment processing being processing of increasing display brightness of the display image data in the display to display brightness substantially equal to display brightness in the first display mode.
